(19) United States
(12) Patent Application Publication
(10) Pub. No.: US 2026/0065572 A1
(43) Pub. Date: Mar. 5, 2026

(54) GRAPHICS PROCESSING

(71) Applicant: Arm Limited, Cambridge (GB)

(72) Inventors: Yoav Asher LEVY, Kfar-Saba (IL); Tal TZABARI, Tel-Mond (IL); Anna KOBRINSKI, Netanya (IL)

(21) Appl. No.: 18/821,429

(22) Filed: Aug. 30, 2024

(51) Int. Cl. G06T 15/00; G06T 15/06; G06T 15/08

(52) U.S. Cl. CPC G06T 15/005; G06T 15/06; G06T 15/08

(57) ABSTRACT

The present disclosure relates to a graphics processor and a method of operating a graphics processing system for rendering a frame that represents a view of a scene comprising one or more objects using a ray tracing process. A traversal of a ray tracing acceleration data structure indicative of the distribution of geometry for the scene being rendered is performed to determine a first end node associated with a first internal node that will be intersected by a ray and requests data associated with the first end node from the local memory as well as requesting a prefetch of data associated with a second node of the plurality of nodes to be stored in the local memory, and determines, by testing the ray for intersection with the first end node, if the first end node is intersected by the ray.

### Field of the Disclosure

The present invention relates to graphics processing systems, and in particular to the rendering of frames (images) for display.

### Background of the Disclosure

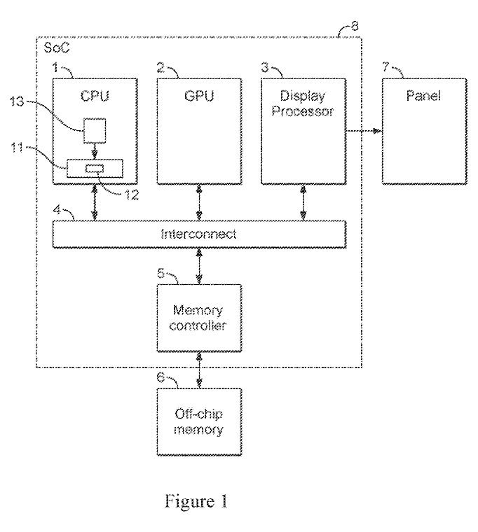

FIG. 1 shows an exemplary system on-chip (SoC) graphics processing system 8 that comprises a host processor in the form of a central processing unit (CPU) 1, a graphics processor (GPU) 2, a display processor 3 and a memory controller 5.

As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 13 such as a game, executing on the host processor (CPU) 1 will, for example, require the display of frames on the display panel 7. To do this, the application will submit appropriate commands and data to a driver 11 for the graphics processor 2 that is executing on the CPU 1. The driver 11 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

One rendering process that may be performed by a graphics processor is so-called "ray tracing". Ray tracing is a rendering process which involves tracing the paths of rays of light from a viewpoint (sometimes referred to as a "camera") back through sampling positions in an image plane into a scene, and simulating the effect of the interaction between the rays and objects in the scene. The output data value, e.g., sampling point in the image, is determined based on the object(s) in the scene intersected by the ray passing through the sampling position, and the properties of the surfaces of those objects. The ray tracing calculation is complex, and involves determining, for each sampling position, a set of objects within the scene which a ray passing through the sampling position intersects.

Ray tracing is considered to provide better, e.g. more realistic, physically accurate images than more traditional rasterisation rendering techniques, particularly in terms of the ability to capture reflection, refraction, shadows and lighting effects. However, ray tracing can be significantly more processing-intensive than traditional rasterisation.

The Applicants believe that there remains scope for improved techniques for performing ray tracing using a graphics processor.

### SUMMARY OF THE DISCLOSURE

According to a first aspect of the present disclosure there is provided a method of operating a graphics processing system when rendering a frame that represents a view of a scene comprising one or more objects using a ray tracing process, the graphics processing system comprising: a graphics processor comprising a programmable execution unit; and a local memory, the method comprising: executing, by the programmable execution unit of the graphics processor, a program to render a frame that represents a view of a scene comprising one or more objects using the ray tracing process; performing a traversal of a ray tracing acceleration data structure indicative of the distribution of geometry for the scene being rendered, the ray tracing acceleration data structure comprising a plurality of nodes, each node associated with a respective one or more volumes within the scene, the plurality of nodes comprising a plurality of internal nodes and a plurality of end nodes that may be intersected by a ray, wherein one or more internal nodes are associated with at least one end node, to determine, by testing the ray for intersection with the volumes represented by the nodes of the acceleration data structure, a first internal node of the plurality of nodes that will be intersected by a ray; determining a first end node associated with the first internal node that will be intersected by a ray; requesting data associated with the first end node from the local memory; requesting a prefetch of data associated with a second node of the plurality of nodes to be stored in the local memory; and determining, by testing the ray for intersection with the first end node, if the first end node is intersected by the ray.

In some embodiments, the method may further comprise determining the data associated with the first end node is not in the local memory and fetching the data associated with the first end node from an external memory.

In some embodiments, the method may further comprise: requesting the prefetched data associated with the second node from the local memory; requesting a prefetch of data associated with a further node of the plurality of nodes, to be stored in the local memory from an external memory; and determining, by testing the ray for intersection with the second node, if the second node is intersected by the ray.

In some embodiments, the second node and/or the further node may be either a further end node associated with the first internal node to be tested for an intersection with the ray, or a further internal node that will be intersected by the ray.

In some embodiments, the second node and/or the further node may be based on its relative location in the ray tracing acceleration data structure. In some embodiments, the second node and/or the further node may be the next node in the ray tracing acceleration data structure.

In some embodiments, the local memory may be cache memory.

In some embodiments, the ray tracing acceleration data structure may comprise a tree structure comprising a plurality of branches associated with a respective plurality of end nodes, wherein each non-end node in the tree structure may be a parent node for a respective set of one or more child nodes, each non-end node thereby being associated with a corresponding respective set of child volumes.

In some embodiments, the end nodes may represent respective subsets of primitives defined for the scene that occupies the volume that the end node corresponds to.

In some embodiments, the method may further comprise queuing the prefetch request.

According to a second aspect of the present disclosure there is provided a graphics processor operable to render a frame representing a view of a scene using a ray tracing process, the graphics processor comprising: a programmable execution unit operable to execute graphics processing programs to perform graphics processing operations; and a local memory; wherein: the programmable execution unit is operable, when the programmable execution unit is executing a program to perform a ray tracing operation that uses a ray tracing acceleration data structure indicative of the distribution of geometry for a scene to be rendered, the ray tracing acceleration data structure comprising a plurality of nodes, each node associated with a respective one or more volumes within the scene, the plurality of nodes comprising a plurality of internal nodes and a plurality of end nodes that may be intersected by a ray, wherein one or more internal nodes are associated with at least one end node, to: perform a traversal of the ray tracing acceleration data structure to determine, by testing the ray for intersection with the volumes represented by the nodes of the acceleration data structure, a first internal node of the plurality of nodes that will be intersected by a ray; determine a first end node associated with the first internal node that will be intersected by a ray; request data associated with the first end node from the local memory; request a prefetch of data associated with a second node of the plurality of nodes to be stored in the local memory; and determine, by testing the ray for intersection with the first end node, if the first end node is intersected by the ray.

In some embodiments, the programmable execution unit may be further operable to: determine the data associated with the first end node is not in the local memory and fetch the data associated with the first end node from an external memory.

In some embodiments, the programmable execution unit may be further operable to: request the prefetched data associated with the second node from the local memory; request a prefetch of data associated with a further node of the plurality of nodes, to be stored in the local memory from an external memory; and determine, by testing the ray for intersection with the second node, if the second node is intersected by the ray.

In some embodiments, the second node and/or the further node may be either a further end node associated with the first internal node to be tested for an intersection with the ray, or a further internal node that will be intersected by the ray.

In some embodiments, the second node and/or the further node may be based on its relative location in the ray tracing acceleration data structure. In some embodiments, the second node and/or the further node may be the next node in the ray tracing acceleration data structure.

In some embodiments, the local memory may be cache memory.

In some embodiments, the ray tracing acceleration data structure may comprise a tree structure comprising a plurality of branches associated with a respective plurality of end nodes, wherein each non-end node in the tree structure may be a parent node for a respective set of one or more child nodes, each non-end node thereby being associated with a corresponding respective set of child volumes.

In some embodiments, the end nodes may represent respective subsets of primitives defined for the scene that occupies the volume that the end node corresponds to.

In some embodiments, the programmable execution unit may be further operable to queue the prefetch request.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

Embodiments of the present disclosure will now be described, by way of example only and with reference to the accompanying drawings, in which:

FIG. 1 shows an exemplary graphics processing system, according to one or more embodiments of the present disclosure.

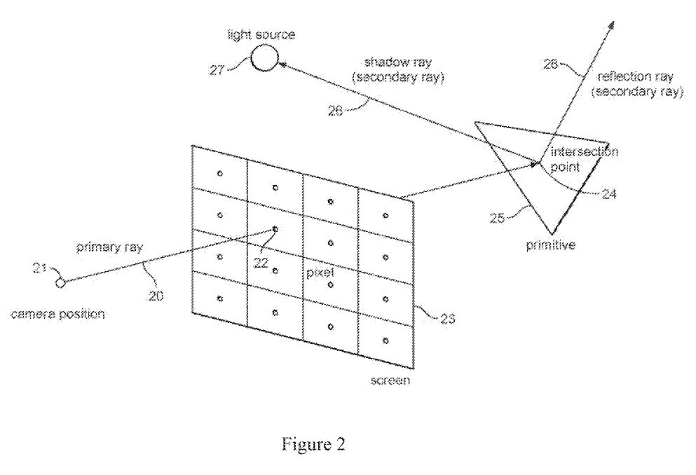

FIG. 2 is a schematic diagram illustrating a "full" ray tracing process, according to one or more embodiments of the present disclosure.

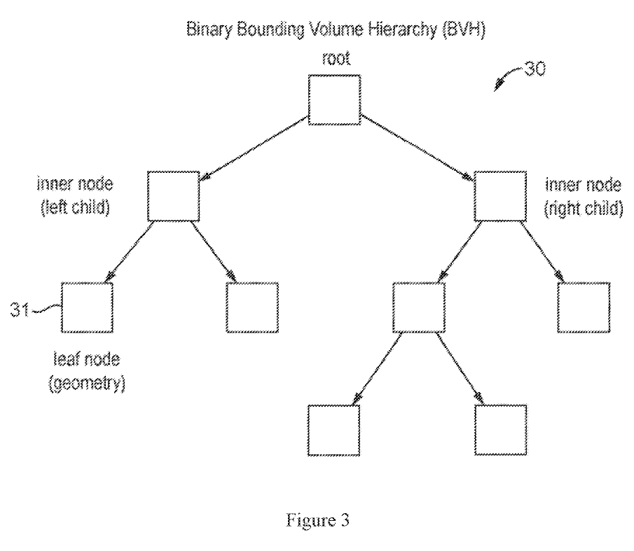

FIG. 3 shows an exemplary ray tracing acceleration data structure, according to one or more embodiments of the present disclosure.

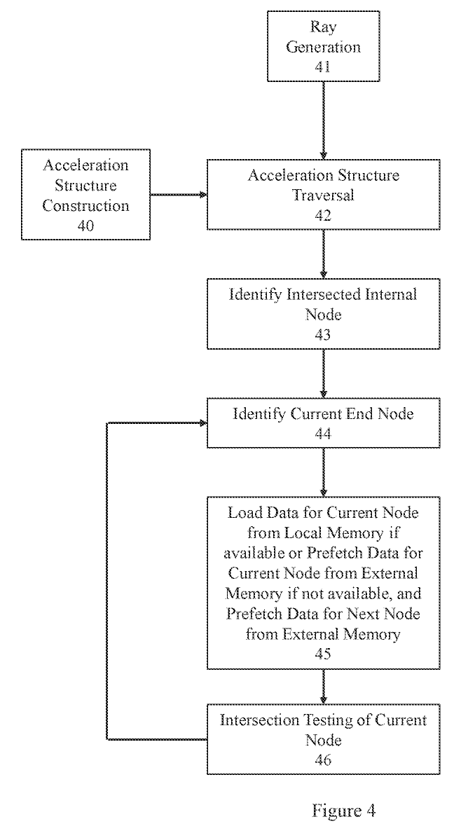

FIG. 4 is a flow chart illustrating a ray tracing process, according to one or more embodiments of the present disclosure.

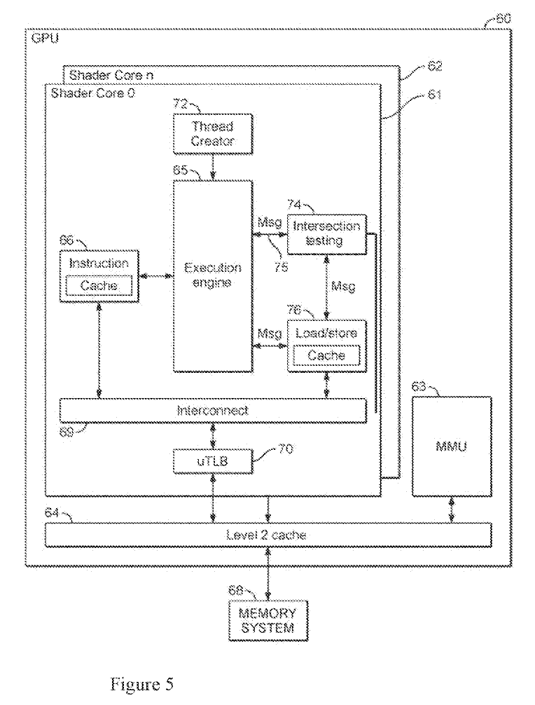

FIG. 5 shows schematically a graphics processor that can be operated according to one or more embodiments of the present disclosure.

### DETAILED DESCRIPTION

The technology described in the present disclosure generally relates to the performing of ray tracing in a graphics processing system in order to render a frame that represents a view of a particular scene. When performing a ray tracing operation, for each ray that is being used to render a sampling position in the frame that is being rendered, in order to render the sampling position, it first needs to be determined which geometry that is defined for the scene is intersected by the ray (if any).

There are various ways in which this can be done, as desired. However, in general, there may be many millions of graphics primitives within a given scene, and millions of rays to be tested, such that it is not normally practical to test every ray against each and every graphics primitive. To speed up the ray tracing operation the present invention therefore uses a ray tracing acceleration data structure, such as a bounding volume hierarchy (BVH), k-d tree, quad tree, octree, BSP-tree, etc., that is representative of the distribution of the geometry in the scene that is to be rendered to determine the intersection of rays with geometry (e.g. objects) in the scene being rendered (and then renders sampling positions in the output rendered frame representing the scene accordingly).

In the present disclosure, the ray tracing operation is performed by a programmable execution unit of the graphics processor executing a graphics processing program to perform the ray tracing operation, which may also be known as a ray-tracing unit (RTU).

However, other arrangements are of course possible. For example, rather than the entire ray tracing operation being performed by the programmable execution unit executing appropriate program instructions for that, at least part of the traversal of the ray tracing acceleration data structure for the ray tracing operation could be performed by a further unit (or circuit), such as a memory management unit (circuit) of the graphics processing system. In other words, rather than the programmable execution unit performing the full ray intersection determination operation, including traversing an acceleration data structure to determine geometry that could be intersected by a ray and then determining whether any geometry is actually intersected by the ray, the programmable execution unit could, in some embodiments, offload some of that processing, and in particular at least a part of the operation of traversing the ray tracing acceleration data structure to determine geometry that could be intersected by a ray, to the further unit (or circuit) of the graphics processing system.

The ray tracing operation according to the present disclosure therefore generally comprises performing a traversal of the ray tracing acceleration data structure for a plurality of rays that are being used for the ray tracing process, which traversal involves testing the rays for intersection with the volumes represented by the different nodes of the ray tracing acceleration data structure in order to determine with reference to the node volumes which geometry may be intersected by which rays for a sampling position in the frame for the scene that is being rendered, and which geometry therefore needs to be further processed for the rays for the sampling position.

The ray tracing acceleration data structure traversal operation therefore involves traversing the nodes of the ray tracing acceleration data structure, testing rays for intersection with the volumes associated with the nodes, and maintaining a record of which node volumes are intersected by which rays, e.g. to determine which nodes should therefore be tested next for the ray, and so on, down to the end nodes, e.g., at the lowest level, of the ray tracing acceleration data structure. For example, and in a particularly preferred embodiment, the ray tracing acceleration data structure comprises a tree structure that is configured such that each end (leaf) node of the tree structure represents a set of primitives defined within the respective volume that the leaf node corresponds to, and with the non-leaf (internal) nodes representing hierarchically-arranged larger volumes up to a root node at the top level of the tree structure that represents an overall volume for the scene in question that the tree structure corresponds to. Each non-leaf (internal) node is therefore preferably a parent node for a respective set of plural child nodes with the parent node volume encompassing the volumes of its respective child nodes. Preferably, each non-leaf (internal) node is therefore associated with a respective plurality of child node volumes, each representing a (preferably non-overlapping) sub-volume within the overall volume represented by the node in question.

In that case, the ray tracing acceleration data structure can thus be (and preferably is) traversed by proceeding down the branches of the tree structure and testing the rays against the child volumes associated with a (internal) node at a first level of the tree structure to thereby determine which child nodes in the next level of the tree structure should be tested, and so on, down to the level of the respective leaf (end) nodes at the end of the branches of the tree structure.

That is, in preferred embodiments, where the ray tracing acceleration data structure comprises a tree structure of this type, the testing of the one or more rays against the volume associated with a node comprises testing the rays against each of the child node volumes associated with the node, and outputting a result of the testing for each of the child nodes of the node in question.

For ease of explanation various embodiments will accordingly be described wherein the ray-volume intersection testing for a node involves testing one or more rays against each of the child node volumes of the node in question. However, it will be appreciated that other arrangements would be possible, e.g. depending on how the ray tracing acceleration data structure is configured and the one or more volumes that are tested for a given node may be any suitable volumes associated with the node such as the volume represented by the node itself rather than the volumes represented by its child nodes. Once it has been determined by performing such a traversal operation for a ray which end nodes represent geometry that may be intersected by a ray, the actual geometry intersections for the ray for the geometry that occupies the volumes associated with the intersected leaf (end) nodes can be determined accordingly, e.g. by testing the ray for intersection with the individual units of geometry (primitives) defined for the scene that occupy the volumes associated with the leaf (end) nodes. Once the geometry intersections for the rays being used to render a sampling position have been determined, it can then be (and is) determined what appearance the sampling position should have, and the sampling position rendered accordingly.

The ray-primitive intersection testing is generally relatively more computationally expensive. The use of the ray tracing acceleration data structure in the present disclosure therefore allows the ray tracing operation to be accelerated.

For instance, rather than testing a ray against each and every individual primitive within the scene, a ray that is being used for the ray tracing process can instead be tested for intersection at a higher level against the volumes represented at each level of the tree data structure, and for any rays that do not intersect a given node in a particular branch of the tree structure it can be determined that the ray does not intersect the geometry falling within the branch of the tree structure including that node, without further testing of the ray against the geometry in the lower levels of the tree.

The use of such a ray tracing acceleration data structure in the present disclosure can therefore be effective in speeding up the overall ray tracing operation.

However, the Applicants have recognised that there is still scope for improvement in this regard.

In particular, the present disclosure recognises that when performing a traversal of the ray tracing acceleration data structure for a ray, in typical cases, a substantial amount of time is spent performing a fetch of the data for each node in order to then perform the intersection testing with the volumes of the nodes of the ray tracing acceleration data structure. The data for each node is typically stored in an external memory whilst the RTU performs the intersection testing based on data for a given node in local memory (e.g., an RTU cache memory). Thus, in order to perform intersection testing for a given node the data for the given node needs to be fetched from the external memory to the local memory of the RTU, which typically takes hundreds of cycles. In other words, the RTU has to wait hundreds of cycles before being able to perform the intersection testing which introduces, or incurs, a substantial amount of “wasted” time, thereby reducing the overall efficiency and performance of the ray-tracing operation by the RTU.

The present invention therefore aims to improve the overall efficiency and performance of the ray-volume intersection testing operations that are required to be performed when performing a traversal of the ray tracing acceleration data structure during the ray tracing operation.

This is achieved in the present invention by either, or both of, prefetching a second end (leaf) node when there are further end (leaf) nodes associated with an internal node that is currently being processed, e.g., tested, for an intersection with one or more rays, and prefetching a second internal (non-leaf) node, which in embodiments the second internal node is at the lowest level minus one of the traversal acceleration data structure. Accordingly, embodiments of the present disclosure are advantageous as the “wasted” cycles of processing time required for fetching the data for a given node that will (i.e. not speculative) be tested for an intersection with one or more rays will be eliminated, or substantially reduced. Thus, the advantageous prefetch feature of the present disclosure, prefetches data in advance relating to nodes that will need to be fetched, rather than any speculative prefetching of data that might, or might not, be required in the near future based on, for example, statistical modelling or any other form of analysis. For example, the node to be prefetched may be based on its location in the acceleration data structure relative to the current node, e.g. the next leaf node in the acceleration data structure that is to be tested for an intersection with one or more rays and/or the next internal node that includes geometry that will be intersected by the one or more rays, wherein the next internal node includes one or more leaf nodes to be tested for intersection with the one or more rays. The determination, or selection, of the node to be prefetched may be based on the, or a prior, traversal of the acceleration data structure, and/or based on a list, or array, of nodes that have been identified as nodes that may be intersected by one or more rays based on the, or prior, traversal of the acceleration data structure. Other arrangements are of course possible to determine the node to be prefetched.

For example, in the case of an RTU traversing the acceleration data structure to perform intersection testing of five leaf (end) nodes of an associated internal node, according to the conventional technique, the RTU will check for the data associated with the first leaf (end) node in local memory (e.g. RTU cache), which may be via a request or load message. The data will not be stored in the local memory and therefore the RTU will request, or message, for the data for the first leaf node to be fetched to local memory, and a delay of hundreds of cycles will be incurred as the necessary data is transferred to local memory from an external memory. Once the data for the first leaf node has been transferred to the RTU local memory the RTU performs the intersection testing for the first leaf node. Once the intersection testing for the first leaf node is completed then the RTU will check for the data associated with the second leaf node in local memory (e.g. RTU cache). The data will not be stored in the local memory and therefore the RTU will request, or message, for the data for the second leaf node to be fetched to local memory, and a further delay of hundreds of cycles will be incurred as the necessary data is transferred to local memory from an external memory. Once the data for the second leaf node has been transferred to the RTU local memory the RTU performs the intersection testing for the second leaf node. This process is then repeated for the third to fifth leaf nodes. As such, the traversal operation time is equivalent to the fetching time for each of the five leaf nodes and the intersection testing processing time for each of the five leaf nodes.

In contrast, in embodiments of the present disclosure the RTU will issue a message, or instruction, for the data for the current (e.g. first) leaf (end) node to be obtained, or loaded, from local memory (e.g. RTU cache), for example, via a request or load message/instruction to the local memory. The data for the current (first) leaf node will typically not be stored in the local memory and therefore will be fetched to local memory from the external memory, for example, via a request message or instruction. Additionally, the RTU will request, at the same, or substantially at the same, time (e.g. in the same message/instruction for the data for the current (e.g. first) leaf node, or in a subsequent separate message/instruction) for a prefetch of the data for the next (e.g. second) leaf node to the local memory from the external memory, wherein the next (e.g. second) leaf node may be based (e.g. selected, or determined) on its relative location in the acceleration data structure, for example, the relative location of the next leaf node to the current leaf node, e.g. the next node in the acceleration data structure to be tested for an intersection with the one or more rays. Once the data for the current (e.g. first) leaf node is available in the local memory (e.g. fetched from the main memory) the RTU performs the intersection testing for the first leaf node. Once the intersection testing for the current (e.g. first) leaf node is completed then the RTU moves onto the next (e.g. second) leaf node, which becomes the current leaf node, and issues a message, or instruction, to request, or load, the data associated with the current (e.g. second) leaf node from local memory (e.g. RTU cache) and, as part of the same message/instruction, or via an additional message/instruction, request the prefetching of the data associated with the next (e.g. third) leaf node, wherein the next (e.g. third) leaf node may be based (e.g. selected, or determined) on its relative location in the acceleration data structure, for example, the relative location of the next leaf node to the current leaf node, e.g. the next node in the acceleration data structure to be tested for an intersection with the one or more rays, if further leaf nodes are associated with the internal node. As the data for the current (e.g. second) leaf node has been prefetched to local memory then the RTU can perform the intersection testing for the second leaf node. This process is then repeated for any further leaf nodes in an iterative process. As such, the traversal operation time is equivalent to the fetching time for a single (i.e. the first) leaf node and the intersection testing processing time for each of the five leaf nodes as the data associated with each subsequent leaf node of the internal node has been prefetched in advance. As can be seen, the process of perfecting the next leaf node in advance substantially reduces the “wasted” hundreds of cycles incurred by the conventional technique meaning that embodiments of the present disclosure are more efficient and have an increased performance.

Once the RTU reaches the final leaf node (e.g. the fifth leaf node in the above example) then the RTU can request, or message, for the data associated with the next internal node that will be intersected by a ray, at the level above the leaf nodes (e.g. the lowest level of the acceleration data structure minus one) to be prefetched to the local memory of the RTU from the external memory, in preparation to perform intersection testing of one or more leaf nodes associated with the next internal node that will be intersected by a ray. The next internal node may be based (e.g. selected, or determined) on its the relative location of the next internal node to the current internal node, or current leaf node, e.g. the next internal node in the acceleration data structure, that has been identified, or determined, from the, or a prior, traversal of the acceleration data structure as including geometry (e.g. one or more leaf nodes) that will be intersected by the one or more rays. Other arrangements are of course possible.

Thus, in the present disclosure, the data associated with the next node (e.g. leaf node or internal node) to be processed for intersection testing is prefetched from external memory to local memory such that once the RTU arrives at the next node to perform intersection testing the data is available in the local memory, thereby making a significant saving in the time required to fetch the data and improving the efficiency and performance of the RTU.

Thus, in embodiments, the method comprises (and the processing circuit of the graphics processing system is configured to perform a step of) including in a program to perform a ray tracing acceleration data structure traversal, a set of one or more instructions that cause program to request a prefetch of data for a further node (e.g., in advance) to local memory as well as loading the data from the local memory for a current node.

The present disclosure can be used for any form of ray tracing based rendering.

Thus, for example, the present disclosure can be used for and when a "full" ray tracing process is being used to render a scene, i.e. in which so-called "primary" rays are cast from a view point (the camera) through a sampling position in the image frame to determine the intersection of that ray with objects in the scene, e.g., and in an embodiment, to determine, for each ray, a closest object in a scene that the ray intersects (a "first intersection point" of the ray). The process may involve casting further (secondary) rays from the respective first intersection points of primary rays with objects in the scene, and additionally using the intersection data for the secondary rays in determining the rendering of the sampling positions.

In this case, the operation in the manner of the present disclosure may be, and is in an embodiment, used when and for analysing the intersections of both primary and secondary rays with objects in the scene.

The present disclosure can also be used for so-called "hybrid" ray tracing rendering processes, e.g. in which both ray tracing and rasterisation processes are performed when performing rendering (e.g. in which only some of the steps of a full ray tracing process are performed, with a rasterisation process or processes being used to implement other steps of the "full" ray tracing process). For example, in an exemplary hybrid ray tracing process, the first intersection of each of the primary rays with objects in the scene may be determined using a rasterisation process, but with the casting of one or more further (secondary) rays from the determined respective first intersection points of primary rays with objects in the scene then being performed using a ray tracing process.

In this case, the operation in the manner of the present disclosure may be, and is in an embodiment, used when and for analysing the intersections of the secondary rays with objects in the scene.

The ray-tracing based rendering of a frame that is performed in the present disclosure is triggered and performed by the programmable execution unit of the graphics processor executing a graphics processing program that will cause (and that causes) the programmable execution unit to perform the necessary ray tracing rendering process.

Thus, a graphics shader program or programs, including a set (sequence) of program instructions that when executed will perform the desired ray tracing rendering process, will be issued to the graphics processor and executed by the programmable execution unit. The shader program(s) may include only instructions necessary for performing the particular ray tracing based rendering operations, or it may also include other instructions, e.g. to perform other shading operations, if desired.

Subject to the particular operation in the manner of the present disclosure, the execution of the shader program to perform the desired ray tracing process can otherwise be performed in any suitable and desired manner, such as, and in an embodiment, in accordance with the execution of shader programs in the graphics processor and graphics processing system in question.

Thus, the graphics processor (the programmable execution unit of the graphics processor) will operate to execute the shader program(s) that includes a sequence of instructions to perform the desired ray tracing rendering process, for plural, and in an embodiment for each, sampling position, of the frame that is to be rendered.

The ray tracing rendering shader program(s) that is executed by the programmable execution unit can be prepared and generated in any suitable and desired manner.

In an embodiment, it is, or they are, generated by a compiler (a shader compiler) for the graphics processor of the graphics processing system in question (and thus the processing circuit that generates the shading program in an embodiment comprises an appropriate compiler circuit). The compiler is in an embodiment executed on an appropriate programmable processing circuit of the graphics processing system.

In a graphics processing system that is operable in the manner of the present disclosure, in embodiments of the present invention at least, a compiler, e.g. executing on a host processor, will generate and issue to the graphics processor one or more shader programs that when executed will perform the required ray tracing-based rendering operations in accordance with the present disclosure, with the graphics processor (the programmable execution unit of the graphics processor) then executing the programs to perform the ray tracing-based rendering, and as part of that program execution exchanging the messages discussed above with the ray tracing acceleration data structure traversal circuit of the graphics processor.

The operation of the present disclosure can be (and is) implemented and triggered by including appropriate prefetching instructions in the ray tracing rendering shader program to be executed by the programmable execution unit that will trigger the desired prefetch of the data associated with a node in advance to be performed, e.g., and in preferred embodiments, by triggering the execution unit to send an appropriate message to the intersection testing circuit (with the execution unit then sending the message when it reaches (executes) the relevant instruction in the shader program).

Such instructions can be included in a shader program to be executed by the programmable execution unit in any suitable and desired manner and by any suitable and desired element of the overall data (graphics) processing system.

For instance, in an embodiment, the fetching/prefetching instruction is included in the shader program by the compiler (the shader compiler) for the graphics processor. Thus the compiler in an embodiment inserts a fetch/prefetch instruction at the appropriate point in the ray tracing rendering shader program that is performing the ray tracing.

In an embodiment, the compiler analyses the shader program code that is provided, e.g. by the application on the host processor that requires the graphics processing, and includes a fetch/prefetch instruction or instructions at the appropriate point(s) in the shader program (e.g. by inserting the instruction(s) in the (compiled) shader program).

The compiler (the compiler processing circuit) is in an embodiment part of, and in an embodiment executes on, a central processing unit (CPU), such as a host processor, of the graphics processing system, and is in an embodiment part of a driver for the graphics processor that is executing on the CPU (e.g. host processor). In this case, the compiler and compiled code will run on separate processors within the overall graphics processing system. However, other arrangements would be possible, such as the compiler running on the same processor as the compiled code, if desired.

The compilation process (the compiler) can generate the ray tracing rendering shader program in any suitable and desired manner, e.g., and in an embodiment, using any suitable and desired compiler techniques for that purpose.

Thus, preferably, the shader program is generated by the compiler, and the compiler is arranged to include within the shader program the instructions that are used in the present disclosure. Other arrangements would, of course, be possible.

The generated shader program can then be issued to the programmable execution unit of the graphics processor for execution thereby.

As will be appreciated by those skilled in the art, these additional aspects of the present disclosure relating to the operation of the compiler and/or the graphics processor can, and preferably do, include any one or more or all of the features of the present disclosure described herein, as appropriate.

When executing the shader program to perform the ray tracing based rendering process, as it is a ray tracing-based rendering process, the performance of that process will include the tracing of rays into and through the scene being rendered, e.g., and in an embodiment, so as to determine how a given sampling position that the ray or rays in question correspond to should be rendered to display the required view of the scene at that sampling position.

The graphics processor can be any suitable and desired graphics processor that includes a programmable execution unit (circuit) that can execute program instructions.

The programmable execution unit can be any suitable and desired programmable execution unit (circuit) that a graphics processor may contain. It should be operable to execute graphics shading programs to perform graphics processing operations.

The graphics processor may comprise a single programmable execution unit, or may have plural execution units. Where there are a plural execution units, each execution unit can, and in an embodiment does, operate in the manner of the present disclosure. Where there are plural execution units, each execution unit may be provided as a separate circuit to other execution units of the data processor, or the execution units may share some or all of their circuits (circuit elements).

The (and each) execution unit should, and in an embodiment does, comprise appropriate circuits (processing circuits/logic) for performing the operations required of the execution unit.

The ray tracing operation according to the present disclosure is performed using a ray tracing acceleration data structure. The ray tracing acceleration data structures that are used and traversed in the present disclosure can be any suitable and desired ray tracing acceleration data structures that are indicative of (that represent) the distribution of geometry for a scene to be rendered and that can be used (and traversed) to determine geometry for a scene to be rendered that may be intersected by a ray being projected into the scene.

The ray tracing acceleration data structure in an embodiment represents (a plurality of) respective volumes within the scene being rendered and indicates and/or can be used to determine geometry for the scene to be rendered that is present in those volumes.

The ray tracing acceleration data structure(s) can take any suitable and desired form. Preferably the ray tracing acceleration data structure(s) comprise a tree structure, such as a bounding volume hierarchy (BVH) tree. The bounding volumes may be axis aligned (cuboid) volumes. Thus, in one embodiment, the ray tracing acceleration data structure comprises a bounding volume hierarchy, and in an embodiment a BVH tree.

The BVH is a tree structure with primitives (which may be triangles, or other suitable geometric objects) at the leaf nodes. The primitives at the leaf nodes are wrapped in bounding volumes. Preferably the bounding volumes are axis aligned bounding boxes. The bounding volumes are then recursively clustered and wrapped in bounding volumes until a single root node is reached. At each level of the recursion two or more bounding volumes may be clustered into a single parent bounding volume. For instance, and in a particularly preferred embodiment, each non-leaf (internal) node has a corresponding plurality of child nodes.

However, other suitable ray tracing acceleration data structures may also be used, as desired. For instance, rather than using a BVH hierarchy, where the scene is subdivided by volume on a per-object basis, e.g. by drawing suitable bounding volumes around subsets of geometry, e.g., and preferably, such that each leaf node (volume) corresponds to a certain number of objects (primitives), the scene could instead be subdivided on a per-volume basis, e.g. into substantially equally sized sub-volumes. For example, the ray tracing acceleration data structure may comprise a k-d tree structure, a voxel (grid hierarchy), etc., as desired. It would also be possible to use 'hybrid' ray tracing acceleration data structures where the scene is subdivided in part on a per-object basis and in part on a per-volume basis. Various other arrangements would be possible, and the present invention may in general be used with any suitable ray tracing acceleration data structure. The ray tracing acceleration data structure that is traversed can be generated and provided in any suitable and desired manner. For example, it may be previously determined and provided, e.g., as part of the definition of the scene to be rendered by the application that requires the graphics processing.

In an embodiment, the ray tracing acceleration data structure is generated by the graphics processor itself, e.g. based on an indication of geometry for the scene that is provided to the graphics processor, e.g. in a preliminary processing pass before the scene is rendered.

It could also or instead be generated by a CPU (e.g. host processor), e.g. based on an indication of geometry for the scene, e.g. in a preliminary processing pass before the scene is rendered.

Other arrangements would, of course, be possible.

The ray tracing acceleration data structure can represent and be indicative of the distribution of geometry for a scene to be rendered in any suitable and desired manner. Thus, it may represent the geometry in terms of individual graphics primitives, or sets of graphics primitives, e.g. such that each leaf node of the tree structure represents a corresponding subset of the graphics primitives defined for the scene that occupies the volume that the leaf node corresponds to. Additionally or alternatively, the ray tracing acceleration data structure could represent the geometry for the scene in the form of higher level representations (descriptions) of the geometry, for example in terms of models or objects comprising plural primitives.

The traversal operation can traverse the ray tracing acceleration data structure(s) for a ray in any suitable and desired manner, e.g., and in an embodiment in dependence upon the form of the ray tracing acceleration data structure that is being traversed. The traversal operation will use the information provided about the ray to traverse the ray tracing acceleration data structure to determine geometry for the scene to be rendered that may be intersected by the ray in question.

Thus, the traversal process in an embodiment operates to traverse the ray tracing acceleration data structure to determine for each volume of the scene that the ray passes through in turn, whether there is any geometry in the volume (indicated by the ray tracing acceleration data structure). Thus, the ray tracing acceleration data structure will be traversed based on the position and direction of the ray, to determine whether there is any geometry in the volumes of the scene along the path of the ray (which could, accordingly, then potentially be intersected by the ray). Other arrangements would, of course, be possible.

In particular, the traversal process involves, for a ray that is being used for the ray tracing process, testing the ray for intersection with one or more (child node) volumes associated with a node of the ray tracing acceleration data structure to determine which of the associated volumes (i.e. child nodes) is intersected by the ray. The traversal process then comprises subsequently testing the ray for intersection with the volumes associated with the (child) node in the next level of the ray tracing acceleration data structure, and so on, down to the lowest level (leaf) nodes. Once the traversal process has worked through the ray tracing acceleration data structure, by performing the required ray-volume intersection testing for the nodes to determine which volumes (represented by end/leaf nodes) contain geometry that may be intersected by the ray, the ray can then be further tested to determine the actual (ray-primitive) intersections with the geometry defined within those volumes (and only within those volumes) (with any intersected geometry then being shaded appropriately).

Subject to the requirements of the present disclosure the traversal can be performed in any suitable fashion, as desired.

The present embodiments relate to the operation of a graphics processor, e.g. in a graphics processing system as illustrated in FIG. 1, when performing rendering of a scene to be displayed using a ray tracing based rendering process.

Ray tracing is a rendering process which involves tracing the paths of rays of light from a viewpoint (sometimes referred to as a "camera") back through sampling positions in an image plane (which is the frame being rendered) into a scene, and simulating the effect of the interaction between the rays and objects in the scene. Each ray may be, and preferably is, defined in terms of the origin (originating position (e.g. x, y, z coordinates)) for the ray that is to be tested (for which the traversal of the ray tracing acceleration data structure is to be determined); the direction of (a direction vector for) the ray that is to traverse the ray tracing acceleration data structure; and the range (distance) that the ray is to traverse (the (minimum and/or maximum) distance the ray is to traverse into the scene).The output data value e.g. colour of a sampling position in the image is determined based on the object(s) in the scene intersected by the ray passing through the sampling position, and the properties of the surfaces of those objects.

The ray tracing process thus involves determining, for each sampling position, a set of objects within the scene which a ray passing through the sampling position intersects.

FIG. 2 illustrates an exemplary "full" ray tracing process. A ray 20 (the "primary ray") is cast backward from a viewpoint 21 (e.g. camera position) through a sampling position 22 in an image plane (frame) 23 into the scene that is being rendered. The point 24 at which the ray 20 first intersects an object 25, e.g. a primitive (which primitives in the present embodiments are in the form of triangles, but may also comprise other suitable geometric shapes), in the scene is identified.

This first intersection will be with the object in the scene closest to the sampling position.

A secondary ray in the form of shadow ray 26 may be cast from the first intersection point 24 to a light source 27. Depending upon the material of the surface of the object 25, another secondary ray in the form of reflected ray 28 may be traced from the intersection point 24. If the object is, at least to some degree, transparent, then a refracted secondary ray may be considered.

Such casting of secondary rays may be used where it is desired to add shadows and reflections into the image. A secondary ray may be cast in the direction of each light source (and, depending upon whether or not the light source is a point source, more than one secondary ray may be cast back to a point on the light source).

In the example shown in FIG. 2, only a single bounce of the primary ray 20 is considered, before tracing the reflected ray back to the light source. However, a higher number of bounces may be considered if desired.

The output data for the sampling position 22 i.e. a colour value (e.g. RGB value) thereof, is then determined taking into account the interactions of the primary, and any secondary, ray(s) cast, with objects in the scene. The same process is conducted in respect of each sampling position to be considered in the image plane (frame) 23.

In order to facilitate such ray tracing processing, in the present embodiments acceleration data structures indicative of the geometry (e.g. objects) in scenes to be rendered are used when determining the intersection data for the ray(s) associated with a sampling position in the image plane to identify a subset of the geometry which a ray may intersect.

The ray tracing acceleration data structure represents and indicates the distribution of geometry (e.g. objects) in the scene being rendered, and in particular the geometry that falls within respective (sub-)volumes in the overall volume of the scene (that is being considered). In the present embodiments, ray tracing acceleration data structures in the form of Bounding Volume Hierarchy (BVH) trees are used.

FIG. 3 shows an exemplary binary BVH tree 30 , constructed by enclosing the complete scene in an axis-aligned bounding volume (AABV), e.g. a cube, and then recursively subdividing the bounding volume into successive pairs of two sub-AABVs according to any suitable and desired, and, e.g. various, subdivision schemes (e.g. same number of objects per child, based on traversal cost, etc.), until a desired smallest subdivision (volume) is reached.

Thus, each node in the BVH tree 30 will have a respective volume of the scene being rendered associated with it, with the end, leaf nodes 31 each representing a particular, smallest subdivided volume of the scene, and any parent (internal) node representing, and being associated with, the volume of its child nodes. Each leaf (end) node will also correspondingly be associated with the geometry defined for the scene that falls, at least in part, within the volume that the leaf (end) node corresponds to (e.g. whose centroid falls within the volume in question). The BVH tree acceleration data structure also stores (either for the nodes themselves or otherwise, e.g. as sideband information), appropriate information to allow the tree to be traversed volume-by-volume on the basis of the origin and direction of a ray so as to be able to identify a leaf node representing a volume that the ray passes through.

This then allows and facilitates testing a ray against the hierarchy of bounding volumes in the BVH tree until a leaf node is found to test the geometry associated with the particular leaf node for intersection with the ray.

FIG. 4 is a flow chart showing the ray tracing process in embodiments of the technology described herein, and that will be performed on and by the graphics processor 2. In particular, the flowchart of FIG. 4 relates to the prefetching of data relating to leaf (end) nodes of an internal node that will be intersected by a ray.

First, the geometry of the scene is analysed and used to obtain an acceleration data structure (step 40), for example in the form of a BVH tree structure, as discussed above. This can be done in any suitable and desired manner, for example by means of an initial processing pass on the graphics processor 2.

A ray is then generated, passing from a camera through a particular sampling position in an image plane (frame) (step 41). The acceleration data structure is then traversed for the ray (step 42), and an internal node, associated with one or more leaf nodes, that will be intersected by the ray (e.g. corresponding to a volume that the ray passes through which contains geometry which the ray potentially intersects) is identified (step 43). A current (e.g., a first) leaf node associated with the internal node is then identified (step 44) and a request message to load data (e.g. the geometry, e.g. primitives) of the current (e.g. first) leaf node from local memory (e.g. cache memory) is issued (step 45). The data for the current (first) leaf node will typically not be stored in the local memory (e.g. not available) and therefore will be fetched to local memory from the external memory, for example, via a request message or instruction. In subsequent iterations, the data for the current (e.g. second onwards) leaf node will be stored in the local memory (e.g. will be available) as the data will have been prefetched to local memory from the external memory in the previous iteration.

At the same time, or substantially at the same time, as requesting to load data of the current leaf node or to fetch the data for the current (first) leaf node, e.g. in the same message, or in an additional message, a request message for a prefetch for the data of a next (e.g. a second) node, which in this example, is a second leaf node associated with the internal node, is issued (step 45) , wherein the next (e.g. second) leaf node may be based (e.g. selected, or determined) on its relative location in the acceleration data structure, for example, the relative location of the next leaf node to the current leaf node, e.g. the next node in the acceleration data structure to be tested for an intersection with the one or more rays.

Once the data relating to the current (first) leaf node is available from the local (cache) memory it is then determined whether the ray intersects any of the geometry, e.g. primitives, in the current (first) leaf node (step 46) and the process moves onto the next (e.g. second) leaf node which becomes the current leaf node (step 47).

A message to load the data associated with the current (e.g. second) leaf node from local memory is issued as well as a prefetch of data relating to next (e.g. third) leaf node (if any) to local memory (step 45) , wherein the next (e.g. third) leaf node may be based (e.g. selected, or determined) on its relative location in the acceleration data structure, for example, the relative location of the next leaf node to the current leaf node, e.g. the next node in the acceleration data structure to be tested for an intersection with the one or more rays. As the data for the current (e.g. second) leaf node was prefetched previously (i.e. in advance) then the data will be available in the local memory so that it can then be determined whether the ray intersects any of the geometry, e.g. primitives, in the current (e.g. second) leaf node (step 46).

The process proceeds iteratively (step 47) for any remaining leaf nodes associated with the internal node, that is a message to load the data associated with the current leaf node from local memory is issued as well as a prefetch of data relating to the next leaf node (if any) in advance to local memory, wherein the next leaf node may be based (e.g. selected, or determined) on its relative location in the acceleration data structure, for example, the relative location of the next leaf node to the current leaf node, e.g. the next node in the acceleration data structure to be tested for an intersection with the one or more rays. As the data for the current leaf node was prefetched previously then the data will be available in the local memory so that it can then be determined whether the ray intersects any of the geometry, e.g. primitives, in the current leaf node. The prefetch requests may be queued depending on the number of prefetch requests and/or load requests currently being serviced, or performed, in order to operatively control and manage the fetch/prefetch requests.

In the above example, data for the next leaf (end) node of an internal node was prefetched in advance of performing intersection testing of the next leaf (end) node. Once the data for the final leaf node of the leaf nodes associated with a given internal node has been prefetched, prior to performing an intersection test on the final leaf node with the ray, then the present disclosure may issue a request message, or instruction, to prefetch data associated with a next (further) internal node that will be intersected by the ray. The next internal node may be based (e.g. selected, or determined) on its relative location to the current internal node, or current leaf node, e.g. the next internal node in the acceleration data structure, that has been identified, or determined, from the, or a prior, traversal of the acceleration data structure as containing geometry (e.g. one or more leaf nodes) that will be intersected by the one or more rays. Other arrangements are of course possible. The issued request message, or instruction, may be part of, or separate to, the message to load the data from local memory for the last leaf node once the last leaf node becomes the current node. Thus, the data for the next internal node will be available in local memory (e.g. cache) in advance of intersection testing one or more leaf nodes of the next (further) internal node. In embodiments, the next internal node is one that is associated with one or more leaf (end) nodes, that is the next internal node is at a level directly above the leaf nodes, wherein the leaf nodes may be considered to be the deepest, or lowest, level of the acceleration data structure, and as such the next internal node may be considered to be the deepest, or lowest level, minus one. However, other arrangements are of course possible where the next internal node that will be intersected by a ray may be at a higher level in the acceleration data structure.

In the above-described embodiments and examples, only the next node (e.g. leaf (end) node, or internal node) is prefetched in advance. However, other arrangements are possible as the limitation to the number of next node(s) is typically dependent upon the available size of local (cache) memory. Thus, if the local memory is of a sufficient size then any number of further nodes can be prefetched in advance as required and based on the available local (e.g. cache) memory.

The present embodiments relate in particular to the operation of a graphics processor when performing ray tracing-based rendering, e.g. as described above with reference to FIGS. 2 to 4, and in particular to the ray tracing acceleration data structure traversal and geometry intersection (steps 42 to 47 shown in FIG. 4) performed as part of the ray tracing operation.

FIG. 5 shows schematically the relevant elements and components of a graphics processor (GPU) 60 of the present embodiments.

As shown in FIG. 5, the GPU 60 includes one or more shader (processing) cores 61, 62 together with a memory management unit 63 and a level 2 cache 64 which is operable to communicate with an off-chip memory system 68 (e.g. via an appropriate interconnect and (dynamic) memory controller).

FIG. 5 shows schematically the relevant configuration of one shader core 61, but as will be appreciated by those skilled in the art, any further shader cores of the graphics processor 60 will be configured in a corresponding manner.

(The graphics processor (GPU) shader cores 61, 62 are programmable processing units (circuits) that perform processing operations by running small programs for each "item" in an output to be generated such as a render target, e.g. frame. An "item" in this regard may be, e.g. a vertex, one or more sampling positions, etc. The shader cores will process each "item" by means of one or more execution threads which will execute the instructions of the shader program(s) in question for the "item" in question. Typically, there will be multiple execution threads each executing at the same time (in parallel). FIG. 5 shows the main elements of the graphics processor 60 that are relevant to the operation of the present embodiments. As will be appreciated by those skilled in the art there may be other elements of the graphics processor 60 that are not illustrated in FIG. 5. It should also be noted here that FIG. 5 is only schematic, and that, for example, in practice the shown functional units may share significant hardware circuits, even though they are shown schematically as separate units in FIG. 5. It will also be appreciated that each of the elements and units, etc., of the graphics processor as shown in FIG. 5 may, unless otherwise indicated, be implemented as desired and will accordingly comprise, e.g., appropriate circuits (processing logic), etc., for performing the necessary operation and functions.

As shown in FIG. 5, each shader core of the graphics processor 60 includes an appropriate programmable execution unit (execution engine) 65 that is operable to execute graphics shader programs for execution threads to perform graphics processing operations.

The shader core 61 also includes an instruction cache 66 that stores instructions to be executed by the programmable execution unit 65 to perform graphics processing operations. The instructions to be executed will, as shown in FIG. 5, be fetched from the memory system 68 via an interconnect 69 and a micro-TLB (translation lookaside buffer) 70.

The shader core 61 also includes an appropriate load/store unit 76 in communication with the programmable execution unit 65, that is operable, e.g., to fetch and prefetch into an appropriate cache, data, etc., to be processed by the programmable execution unit 65, and to write data back to the memory system 68. Again, such data will be fetched/prefetched/stored by the load/store unit 76 via the interconnect 69 and the micro-TLB 70.

In order to perform graphics processing operations, the programmable execution unit 65 will execute graphics shader programs (sequences of instructions) for respective execution threads (e.g. corresponding to respective sampling positions of a frame to be rendered).

Accordingly, as shown in FIG. 5, the shader core 61 further comprises a thread creator (generator) 72 operable to generate execution threads for execution by the programmable execution unit 65.

As shown in FIG. 5, the shader core 61 also includes an intersection testing circuit 74, which is in communication with the programmable execution unit 65, and which is operable to perform the required ray-volume testing during the ray tracing acceleration data structure traversals (i.e. the operation of step 42 of FIG. 4) for rays being processed as part of a ray tracing-based rendering process, in response to messages 75 received from the programmable execution unit 65. In the present embodiments the intersection testing circuit 74 is also operable to perform the required ray-primitive (intersection) testing (i.e. the operation of step 46 of FIG. 4). The intersection testing circuit 74 is also able to communicate with the load/store unit 76 for fetching and/or prefetching in the required data for such intersection testing.

In the present embodiments, the intersection testing circuit 74 of the graphics processor is a (substantially) fixed-function hardware unit (circuit) that is configured to perform the required ray-volume and ray-primitive intersection testing during a traversal of a ray tracing acceleration data structure to determine geometry for a scene to be rendered that may be (and is) intersected by a ray being used for a ray tracing operation.

Subject to the requirements for operation in the manner of the present disclosure, the graphics processor can otherwise have any suitable and desired form or configuration of graphics processor and comprise and execute any other suitable and desired processing elements, circuits, units and stages that a graphics processor may contain, and execute any suitable and desired form of graphics processing pipeline.

In an embodiment, the graphics processor is part of an overall graphics (data) processing system that includes, e.g., and in an embodiment, a host processor (CPU) that, e.g., executes applications that require processing by the graphics processor. The host processor will send appropriate commands and data to the graphics processor to control it to perform graphics processing operations and to produce graphics processing output required by applications executing on the host processor. To facilitate this, the host processor should, and, in an embodiment does, also execute a driver for the graphics processor and a compiler or compilers for compiling programs to be executed by the programmable execution unit of the graphics processor.

The overall graphics processing system may, for example, include one or more of: a host processor (central processing unit (CPU)), the graphics processor (processing unit), a display processor, a video processor (codec), a system bus, and a memory controller.

The graphics processor and/or graphics processing system may also comprise, and/or be in communication with, one or more memories and/or memory devices that store the data described herein, and/or the output data generated by the graphics processor, and/or store software (e.g. (shader) programs) for performing the processes described herein. The graphics processor and/or graphics processing system may also be in communication with a display for displaying images based on the data generated by the graphics processor.

The present disclosure can be implemented in any suitable system, such as a suitably configured micro-processor based system. In an embodiment, the present disclosure is implemented in a computer and/or micro-processor based system. The present disclosure is in an embodiment implemented in a portable device, such as, and in an embodiment, a mobile phone or tablet.

The various functions of the present disclosure can be carried out in any desired and suitable manner. For example, the functions of the present disclosure can be implemented in hardware or software, as desired. Thus, for example, unless otherwise indicated, the various functional elements, stages, units, and "means" of the present disclosure may comprise a suitable processor or processors, controller or controllers, functional units, circuitry, circuits, processing logic, microprocessor arrangements, etc., that are operable to perform the various functions, etc., such as appropriately dedicated hardware elements (processing circuitry/circuits), and/or programmable hardware elements (processing circuitry/circuits) that can be programmed to operate in the desired manner.

It should also be noted here that, as will be appreciated by those skilled in the art, the various functions, etc., of the present disclosure may be duplicated and/or carried out in parallel on a given processor. Equally, the various processing stages, etc., may share processing circuitry/circuits, etc., if desired.

The methods in accordance with the present disclosure may be implemented at least partially using software e.g. computer programs. It will thus be seen that when viewed from further embodiments the present disclosure provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc. The present disclosure also extends to a computer software carrier comprising such software which when used to operate a display processor, or microprocessor system comprising a data processor causes in conjunction with said data processor said controller or system to carry out the steps of the methods of the present invention. Such a computer software carrier could be a physical storage intermediate such as a ROM chip, CD ROM, RAM, flash memory, or disk, or could be a signal such as an electronic signal over wires, an optical signal or a radio signal such as to a satellite or the like.

It will further be appreciated that not all steps of the methods of the present disclosure need be carried out by computer software and thus from a further broad embodiment the present disclosure provides computer software and such software installed on a computer software carrier for carrying out at least one of the steps of the methods set out herein.

The present disclosure may accordingly suitably be embodied as a computer program product for use with a computer system. Such an implementation may comprise a series of computer readable instructions either fixed on a tangible, non-transitory intermediate, such as a computer readable intermediate, for example, diskette, CD ROM, ROM, RAM, flash memory, or hard disk. It could also comprise a series of computer readable instructions transmittable to a computer system, via a modem or other interface device, over either a tangible intermediate, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable intermediate with accompanying printed or electronic documentation, for example, shrink wrapped software, preloaded with a computer system, for example, on a system ROM or fixed disk, or distributed from a server or electronic bulletin board over a network, for example, the Internet or World Wide Web.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

What is claimed is:

1. A method of operating a graphics processing system when rendering a frame that represents a view of a scene comprising one or more objects using a ray tracing process, the graphics processing system comprising: a graphics processor comprising a programmable execution unit; and a local memory, the method comprising:
executing, by the programmable execution unit of the graphics processor, a program to render a frame that represents a view of a scene comprising one or more objects using the ray tracing process;
performing a traversal of a ray tracing acceleration data structure indicative of the distribution of geometry for the scene being rendered, the ray tracing acceleration data structure comprising a plurality of nodes, each node associated with a respective one or more volumes within the scene, the plurality of nodes comprising a plurality of internal nodes and a plurality of end nodes that may be intersected by a ray, wherein one or more internal nodes are associated with at least one end node, to determine, by testing the ray for intersection with the volumes represented by the nodes of the acceleration data structure, a first internal node of the plurality of nodes that will be intersected by a ray;
determining a first end node associated with the first internal node that will be intersected by a ray;
requesting data associated with the first end node from the local memory;
requesting a prefetch of data associated with a second node of the plurality of nodes to be stored in the local memory; and
determining, by testing the ray for intersection with the first end node, if the first end node is intersected by the ray.

2. The method of claim 1, further comprising:
determining the data associated with the first end node is not in the local memory and fetching the data associated with the first end node from an external memory.

3. The method of claim 1, further comprising:
requesting the prefetched data associated with the second node from the local memory;
requesting a prefetch of data associated with a further node of the plurality of nodes, to be stored in the local memory from an external memory; and
determining, by testing the ray for intersection with the second node, if the second node is intersected by the ray.

4. The method of claim 3, in which the second node and/or the further node is either a further end node associated with the first internal node to be tested for an intersection with the ray, or a further internal node that will be intersected by the ray.

5. The method of claim 3, in which the second node and/or the further node is based on its relative location in the ray tracing acceleration data structure, preferably wherein the second node and/or the further node is the next node in the ray tracing acceleration data structure.

6. The method of claim 1, in which the local memory is cache memory.

7. The method of claim 1, in which the ray tracing acceleration data structure comprises a tree structure comprising a plurality of branches associated with a respective plurality of end nodes, wherein each non-end node in the tree structure is a parent node for a respective set of one or more child nodes, each non-end node thereby being associated with a corresponding respective set of child volumes.

8. The method of claim 1, in which the end nodes represent respective subsets of primitives defined for the scene that occupies the volume that the end node corresponds to.

9. The method of claim 1, further comprising:
queuing the prefetch request.

10. A graphics processor operable to render a frame representing a view of a scene using a ray tracing process, the graphics processor comprising:
a programmable execution unit operable to execute graphics processing programs to perform graphics processing operations; and a local memory; wherein:
the programmable execution unit is operable, when the programmable execution unit is executing a program to perform a ray tracing operation that uses a ray tracing acceleration data structure indicative of the distribution of geometry for a scene to be rendered, the ray tracing acceleration data structure comprising a plurality of nodes, each node associated with a respective one or more volumes within the scene, the plurality of nodes comprising a plurality of internal nodes and a plurality of end nodes that may be intersected by a ray, wherein one or more internal nodes are associated with at least one end node, to:
perform a traversal of the ray tracing acceleration data structure to determine, by testing the ray for intersection with the volumes represented by the nodes of the acceleration data structure, a first internal node of the plurality of nodes that will be intersected by a ray;
determine a first end node associated with the first internal node that will be intersected by a ray;
request data associated with the first end node from the local memory;
request a prefetch of data associated with a second node of the plurality of nodes to be stored in the local memory; and
determine, by testing the ray for intersection with the first end node, if the first end node is intersected by the ray.

11. The graphics processor of claim 10, in which the programmable execution unit is further operable to:
determine the data associated with the first end node is not in the local memory and fetch the data associated with the first end node from an external memory.

12. The graphics processor of claim 10, in which the programmable execution unit is further operable to:
request the prefetched data associated with the second node from the local memory;
request a prefetch of data associated with a further node of the plurality of nodes, to be stored in the local memory from an external memory; and
determine, by testing the ray for intersection with the second node, if the second node is intersected by the ray.

13. The graphics processor of claim 12, in which the second node and/or the further node is either a further end node associated with the first internal node to be tested for an intersection with the ray, or a further internal node that will be intersected by the ray.

14. The graphics processor of claim 12, in which the second node and/or the further node is based on its relative location in the ray tracing acceleration data structure, preferably wherein the second node and/or the further node is the next node in the ray tracing acceleration data structure.

15. The graphics processor of claim 10, in which the local memory is cache memory.

16. The graphics processor of claim 10, in which the ray tracing acceleration data structure comprises a tree structure comprising a plurality of branches associated with a respective plurality of end nodes, wherein each non-end node in the tree structure is a parent node for a respective set of one or more child nodes, each non-end node thereby being associated with a corresponding respective set of child volumes.

17. The graphics processor of claim 10, in which the end nodes represent respective subsets of primitives defined for the scene that occupies the volume that the end node corresponds to.

18. The graphics processor of claim 10, in which the programmable execution unit is further operable to:
queue the prefetch request.
